(19) United States
(12) Patent Application Publication
(10) Pub. No.: US 2017/0164162 A1
(43) Pub. Date: Jun. 8, 2017

(54) LumenGlow™ virtual switch

(71) Applicants: Nissim Zur, Givataim, IL (US); Eliahu Arad, Tzofit, IL (US)

(72) Inventors: Nissim Zur, Givataim, IL (US); Eliahu Arad, Tzofit, IL (US)

(21) Appl. No.: 14/962,713

(22) Filed: Dec. 8, 2015

(51) Int. Cl. H04W 4/08; H04W 4/00; H04W 52/02

(52) U.S. Cl. CPC H04W 4/08; H04W 52/0254; H04W 4/005; H04W 4/008; H04W 84/18

(57) ABSTRACT

An On-wall, virtual switch, hot spot actuated, electronic control device, makes use of multi point 3D proximity sensing of human finger. The virtual switchhot spot sensors permit a user to input control commands through the use of multi hot spot point proximity sensing over none sensing material as plastic, glasses, wood, marble etc. In such as one- or more fingershovering in front of the surface and hot spots below wake up the virtual switch. After wake up, several hot points can report and as tapping; swiping; tracing; rotating; pinching; and zooming, allowing for a significant increase the potential number of virtual switch commands that can be controlled from, and also in the number of control signals that can be generated by a single small area virtual switch device. The virtual switch device wireless transmits the command to group devices as lamps, wall power, door lock or any other devices that wirelessly connected to virtual switch group. The assign of the multi-point proximity sensing command to virtual switch command is done over smart phone or any computerized devices with same wirelessly capabilities and display. The virtual switch is very thin; battery powered and can be attached to any wall or surface. Any command that is recognized can be feed backed by a buzzer sound. And since it has no sparked contact it can be placed also in hazardous places that encounter electrical shortage caused by water or explosion by gas leakages. Many virtual switches can control the same devices in parallel.

### INCORPORATION BY REFERENCE

This application claims the benefit of, and incorporates by reference, the commonly-owned provisional patent application Ser. No. 62/089,274, filed Dec. 9, 2014, entitled “LumenGlow™ virtual switch” by the inventors of this application.

### 1. BACKGROUND OF THE INVENTION CAPITALIZED TERMS

For convenient reference, some instances of particular terms in the body of various paragraphs below and in the claims are presented in all-capital letters. This serves as a reminder that the all-caps terms are explained in more detail in the Glossary below and/or elsewhere in the description below. Not all instances of an all-caps term are necessarily presented in all-capital letters, though; that fact should not be interpreted as indicating that such other instances have a different meaning.

The invention relates generally to replace the traditional mechanical switch control electronic devices installable on walls. Such mechanical switch control devices are typically used to control connected electrical loads such as lights, fans, wall power, door lock or any other devices that connected to the mains power supply 110V/220V or other voltage. Normally to switch on/off with traditional mechanical switch need one switch (sometimes two) per load. And one wall cavity to control that switch with load wire inside. The invention is a virtual switch groups all control needs with very small place. Using hot spot sensing, battery powered and can be stacked/attached on the wall or any surface in a room. No external power needed. It has small slim front that can wirelessly control many loads or actuators.

Traditional mechanical switch control devices within single- or multiple-gang electrical boxes have evolved in many years. Simple control devices (for example, conventional light switches) control only local loads that are connected to the control devices via existing wiring. Some control devices allow a single load to be controlled from multiple locations, e.g., two simple light switches mounted at different places in a room or elsewhere in a house can each switch a light on or off.

Other control devices use buttons or other features to control a local load in different ways. For example, load controllers that allow dimming of a light often have hard buttons, slides, or rotating knobs that can be pushed, slid, or twisted, thereby causing the light to brighten or dim. At another example, some timer devices allow the user to push one of four or five physical buttons to turn on the timer, and then the timer will automatically shut off. And a still another example, motion-based control devices can automatically turn a load, such as a light, on or off in conjunction with detecting motion or on the absence of it.

Some progressed ?! Control devices, located within a wall switch, can be used to control other devices within a home. These control devices usually control only the local load. Such control devices typically use a fixed number of buttons to allow control signals to be sent via connected wires or via a network using a control protocol (in essence, a common language “spoken” by both the control device and the controlled device). Some control devices allow alternate signals to he sent if a button is pushed in different manners, for example a single tap, rapid double tap, or press-and-hold.

The Problem with Exiting Devices that Use Gesture to Switch Load:

Since the devices that detect hovering and gestures need a lot of power, usually they can't use small CR2032 battery powered, and are designed as in-the-wall devices powered from the mains 220V or 110V. Powered from the main can fit only in exiting wall cavity. They can't move to other places on the wall, can't be added in parallel since a cavity in the wall is needed with powered wire source inside.

### 2. SUMMARY OF THE INVENTION

The invention relates to an on-wall, slim device, and few millimeters thin, slim battery powered that solves the problem of power consumptions utilizing hot spot technologies. The virtual switch device is in deep sleep with neglected battery power consumptions from the battery and wakes up upon detecting the human finger radiates energy into the hot spot sensors pads. The hot spot sensors amplify this energy and wakes up the main virtual switch device's processor. After waking up, other information is collected from all hot spots, interpreting to select one command from many and wirelessly broadcast.

The virtual switch processor reads all the hot spot 3D proximity sensor regarding finger location and movement on front of the panel with time mark and convert that as input control commands through the use of 3D-dimensional gestures such as tapping; one or two fingers swiping; tracing; pinching; and zooming, together allowing for a significant increase in the potential number of virtual switches that can be controlled from, and also in the number of control signals that can be generated by, a single touch-control device.

The virtual switch device control panel is covered by any none nietalize panel and any photo can be printed on the front panel, a number and/or icons.

The virtual switch device may include or connects to many kind of sensors and reading these sensors can wake up the devices and generate wirelessly commands. For example sensors as: light, gas, smoke, fire, radiation, humidity, temperature, air pollution, ozone level, or any analog or digital sensor, can communicate over digital bus as UART, I2C, SPI or digital and Analog I/O.

The virtual switch can disable its hot spot sensors and wakes up also by taping on its surface. This is possible due to the taping detection accelerometer.

The virtual switch device wirelessly links also to other virtual switch devices and forms a wireless mesh network. The same virtual switch devices can be assigned to group of controlled load devices as lamps. One wireless command can activate the entire group.

The virtual switch device can be assigned to several groups, at the same time, and different command can activate devices in different groups.

Since the virtual switch devices are communicating between themselves over mesh network, command to out-of-range to controlled devices can be meshed from virtual switch device to another virtual switch device until the near virtual switch device transmits it to the destination controlled unit.

Since sensors can be attached to virtual switch devices, the virtual switch devices can activate controlled devices in any place in the mesh network. Also far away then the RF range of the virtual switch device attached to the sensor.

Virtual switch device can mesh also with none virtual switch device bridges to internet like a smart phone and a tablet and able to be controlled from the internet or send events from sensors to the internet. The internet meshes all virtual switch devices in remote location too.

### 3. DESCRIPTION OF THE DRAWINGS

FIG. 1 shows examples of the virtual switch device in accordance with the invention. In this example the size is 67 mm×47 mm thickness just 4 mm. Size of the hot spot area 100 can be bigger or smaller. The battery place is 120. The PCB is cut to save total device's height. The hot spot has diamond shape 100. There are leds around 130 that light when needed, a place for light sensor 110 or other sensors. The perspective view showing an on the wall-installable virtual switch device in accordance with the invention; the hot spot 100 facing the user. Behind it there is the wall, other configurations are possible.

FIG. 2 is the virtual switch device's back side. The antenna is 200. A Battery holder 210. Led around the edges showing when a human finger approaches the hot spot 220. A Buzzer 240. And expansion port 250 to link to sensors or external systems. A processor 260. A tap recognition accelerometer 270.A DSP hot spot detector 230.

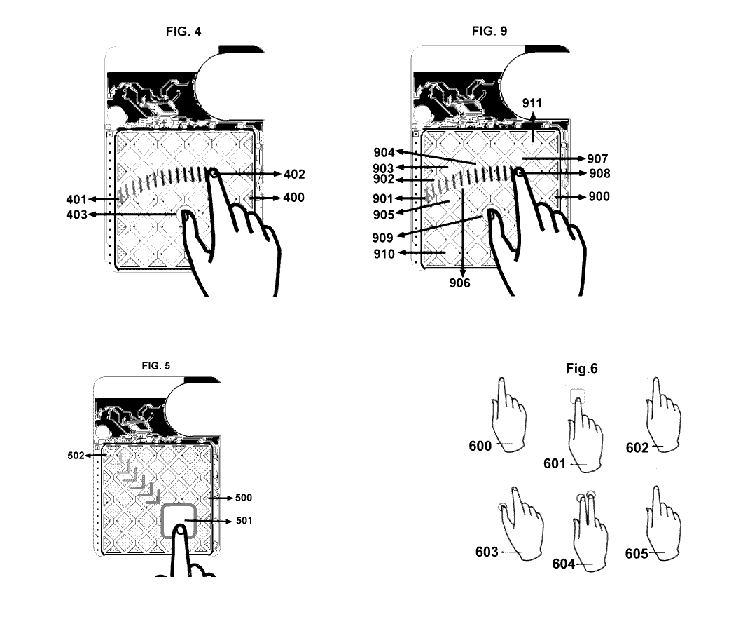

FIG. 3 shows example of how the hot spot 300 works. A human finger 320 approaches. Energy from the finger is detected 310 by one or more hot spots. The front electronics protective panel 330.The virtual switch device's PCB 340.The wall behind 350.

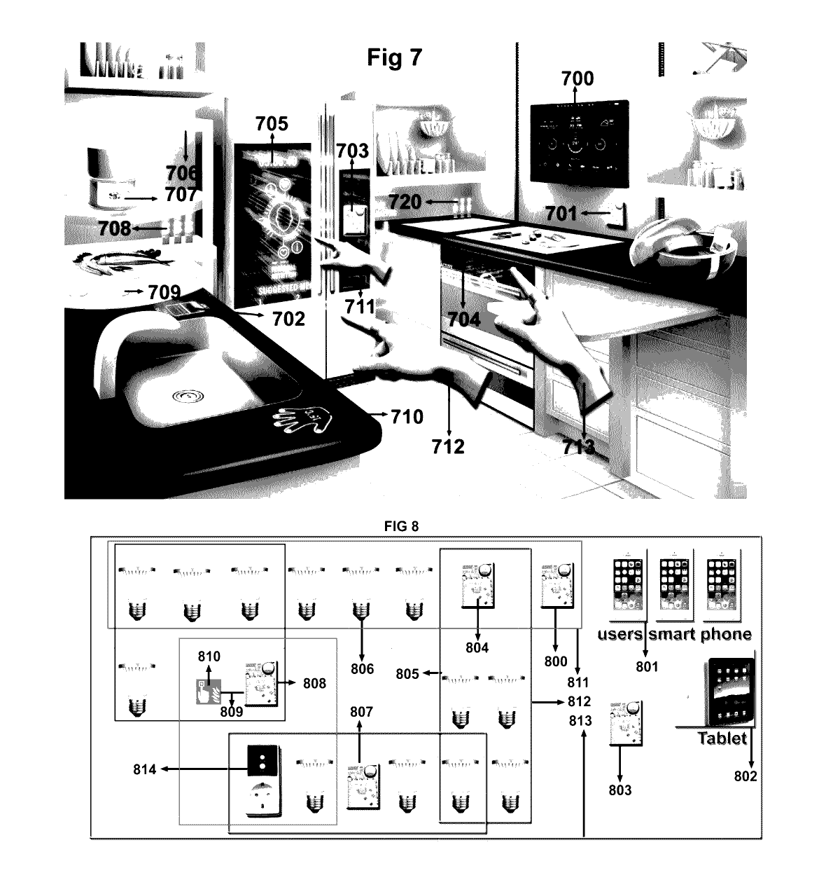

FIG. 4 shows examples of activated, wake up, by hot spot 401 or 403. When finger approaches the virtual switch device's DSP 230 monitors all hot spots been recorded and send to virtual switch processor 260 over digital bus as I2C or SPI. So all Hot spots from near area 401 to 402 and 403 their data is recorded and transferred to processor 260 for future recognizing as switching command. The finger can hover from 401 to 402 in the air, or touches the cover plates. For example this is 8 different command:

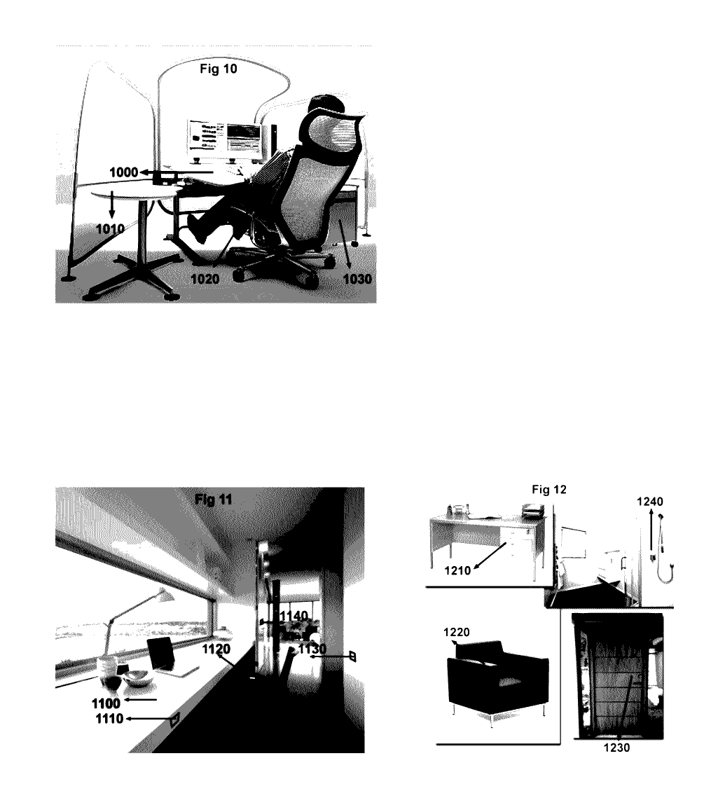

1: Touching area as 403 after that finger slides on parallel surface 401 to 402

2: Touching area as 403 after that Touching 401 and hover in the air and touching 402

3: Touching area as 401 and finger slides on parallel surface to 402

4: Touching area as 401 and hover in the air and touching 402

5: Touching 401 and finger slides on surface from 401 to 402 than touching area 403.

6: Touching 401 and then hover in the air touching 402 than touching area 403.

7: Touching area as 401 then touching 402 than touching area 403.

8: Touching area as 402 and hover in the air then touching 401 than touching area 403.

Since double taping on hot spots is also recognized, double taping on area 403 can double this example command to 16.

Since two fingers can slide or hover from 401 to 402 is also recognized, that double this example command to 32. Any combination of behavior can be translated to different commands.

FIG. 5 shows examples of different commands. Touching hot spot 502 can be one command. Touching and dragging to point 501 can be another command. And staying long on point 501 can be another command too. The virtual switch device's processor detects the edges of the hot spot 500 as possible end command or time elapses with no new data.

FIG. 6 shows an example of how by touching many hot spots, made in different regions of the virtual switch devices hot spot, may be identified by the device as different commands. Examples are: Touch and move 600 up. Touch and move left to downright 601. Hover above the hot spot 602. Touch one point and hover 603. Touch two hot spots 604. Touch and move down 605. The hot spot detects proximity and time passes to aggregate as an important data. Fast tap on area or long stay is a different command.

FIG. 7 shows an example of how the virtual switch devices become a location base beacon in the room. When it comes to wearable pointer and command technology, as Bluetooth Smart ring 711.They all have the same problem. The wearable device can't detect its location in the room. It can have sensors to detect and gesture but since the user can stand in place on the room floor there is no way to know where he is pointing to. Same problem with wearable and smart watches. All of them can't be used for point and activate commands.

Gesture-controlled devices as smart rings slips on the finger so one can use gesture control for TVs 700, phones, tablets 705, light 706 708 709 720, cockers 707 704.

But, when the smart ring's device is bond with all virtual switch devices in the room, it can detects the wireless energies transmitted from 3 or more virtual switch devices and its location is easily calculated. With sensor as electronics compass and angle to horizon detector accelerator, the wearable devices can detect direction and angels. So, pointing device can be detected by these 3 parameters: location in the room, azimuth and angle to horizon. This information can be sent to the virtual switch devices to feed a switching command to the pointed device.

Therefore, two same azimuths, angle as show at 712 and 711 will not activate the same devices. Since the wearable device will detect its location from virtual switch devices at location 701 703 702.

In the other hand, the wearable device can he just wirelessly transmitting its sensors data as azimuths and angles and all virtual switch devices around, detecting presence and with the group mesh in the room, combine the information with other virtual switch devices and send commands to the pointed devices to be controlled/activate as seen by pointing 713. Pointing to light 720 will make the virtual switch device in the room sends command to light 720 to be on/off or dimmed by the angle of the finger.

Virtual switch device 702 is embedded in the table. Virtual switch device's hot spot can also be shaped other than rectangle as seen at 710 with or without display.

The virtual switch device by itself can be shaped as a wearable device and join the home group.

FIG. 8 shows example of several virtual switch devices 800 804 803 807 808 link to groups with wireless led lamp 806 and wireless wall power switch 814.

Virtual switch device 800 group 811 with virtual switch devices 804 and command 6 led lamp.

Virtual switch device 800 and 804 are meshed linked.

Virtual switch device 804 is also in group 812 when lamp 805 exits.

Virtual switch device 807 controls also one lamp from group 813. In its group it has a wireless power switch and a command to the group can activates all the group or only one member in the group as just the power switch 814.

Virtual switch device 808 has a fire and smoke sensor 810 inside 809, so it can acts as normal function virtual switch device but if the sensor is alerted, it can switch all led lights in its group or other groups 813 and send mesh message to tablet 802 to sound a voice alert and forward to internee. Same alert can be sent to user's smart phone 801.

FIG. 9 shows how the hot spots collect the information to feed later to the multi-dimensional array. When user's finger approaches the hot spot 901 the DSP wakes up and start monitors the movement. The movement is traced all over hot spot pads as 902 903 904 905 906 907 908. Since all hot spots are monitored, also none proximity spots are reported as 910 900 911.

FIG. 10 Since a virtual switch device normally mounted on walls, it is also possible to embedded it inside or below other surfaces and uses the far hot spot detection, to detect the used finger over other material. For an example,a virtual switch device in or under a table 1000 to work as a mouse to PC and set command to room light. Virtual switch device can be also embedded in mouse pad 1010 and eliminate the need for mouse. Or at chair anus 1020 and as a drawers locker 1030—where the user has to draw some unique movement to open the drawer.

FIG. 11 Demo of the embedded of the virtual switch devices inside or below larges surfaces as tables 1100 1110, on walls 1130 or behind the surface as inside closets 1140 act as a closets locker.

FIG. 12 Demo of the use of virtual switch device as a drawer locker 1210. Door key 1230. And inside sofas as room light and other remote controlled function. When the virtual switch device acts as a locker, it detects the user's finger behind the wood or other material. Then the user has to draw a unique path in front of the virtual switch device's hot spot, and that drawing's lock will be opened.

For the avoidance of doubt, the written legends shown in some of the drawing figures are for purposes of illustration only and are not intended to limit the scope of the claims.

### 4. DETAILED DESCRIPTION OF SPECIFIC EMBODIMENTS

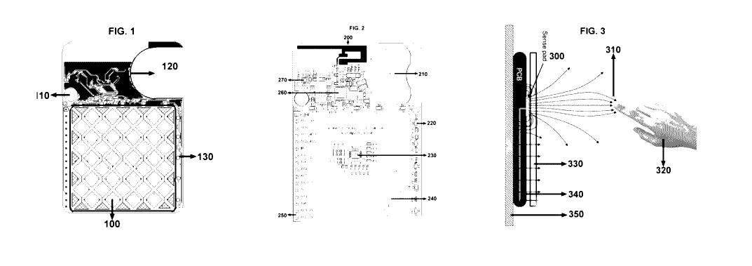

Overview: Referring to FIG. 1 till FIG. 12

An On-wall, virtual switch, hot spot sensors 100, electronic control device, makes use of multi point 3D proximity sensing of human finger 310. The virtual switch hot spot sensors permit a user to input control commands through the use of multi hot spots point proximity sensing over none metal material 330 as plastic, glasses, wood, marble etc. In a state that one- or more fingers hovering in front of the surface 330 and hot spots 100 below wake up the virtual switch processor 260. After wake up, several hot points can report and as tapping; swiping; tracing; rotating; pinching; and zooming, allowing a significant increase of the potential for number of virtual switch commands that can be controlled from, and also in the number of control signals that can be generated by a single small area 330 virtual switch device. The virtual switch device wirelessly transmits 200 the command to group devices 811 as lamps, wall power 814, door lock 1230, gas and water valves or any other devices that wirelessly can connected to virtual switch group 813. The assign of the multi-point proximity sensing command to virtual switch command is done over smart phone 801 or any computerized devices 802 with same wirelessly capabilities and display. The virtual switch is very thin; battery powered 210 and can be attached to any wall or surface. It can he also be attached behind any surface as sofas, arm chairs 1220 tables 1000 1100, mouse pads 1010, chairs arms holder 1120. Any command that is recognized, can be feed backed by a buzzer's sound. And since it has no sparked on command to contact it can be placed also in hazardous places enabling safety like in an environment of water 1240 or gas leakage. Many virtual switches can control the same devices in parallel all FIG. 8. Some virtual switch devices can be attached to sensors as fire 810 and automatically wirelessly transmit commands if the activated condition has detected.

4.1. Components

The virtual switch device is powered by CR2032 or other battery 120 210. It has a processor 260 that transmits the recognized command over antenna 200. The processor communicates with other components on the virtual switch PCB, as accelerometer 270 and Hot spot proximate DSP 230. The processor also has several analog to digital input/output pins and is been used to read analogs sensors as light sensor. The processor also has digital input/output pins where it can digitally communicate with digital sensor PIO or I2C SP1 and UART. The processor 260 has an auto sleep function and it moves to low power state when there is no moving on its hot spot proximity sensor or other sensors attached to preserve battery power. The processor 260 wakes up of its sleep by toggle wake up pin.

The accelerometer 270 has a taping wake up function, and it can wakes up the processor 260 from its deep sleep, to active a state.

The virtual switch DSP 230 has the connection to all hot spats sensor 100. The DSP moves to sleep mode when there is no sensing of any human finger. When a human finger approaches on of the sensor and radiates energy to the hot spot. That energy is amplified and wake ups the DSP and the processor 260.

The signals generated by the hot spot DSP 230 is sent to the processor 260. The processor is running an operating system or a microcontroller running a real-time operating system (RTOS), with suitable programming to perform the operations described below. Such programming is well known within the realm of ordinary skill and therefore is not described here in detail.

The processor builds a multi-dimensional array unique map of all hot spots with data about the proximity to the finger with time mark. Aggregates all the data from all hot spots,multi-dimensional array allows the processor to detect a unique command to wirelessly transmitted.
1. The virtual switch device processor 260 has several leds 220 connected to its digital outputs. These leds are used for several purposes:
2. Visible leds used for feedback for the finger over hot spots, and when a command is recognized and transmitted
3. Ultra violet leds energizes a glow lumen in the dark panel, so the virtual switch device on a wall will be seen in the dark.
4. An Infra-red led is used to send a command to a device that is controlled by IR remote control, as heater and air condition. The virtual switch device acts as a programmable remote control that can transmit remote control command to heater or air cooling system.
   This virtual switch device's command can be generated by:
   1. Local user action on hot spot
   2. Command bridges over the wireless mesh of the virtual switch device.
   3. Sensor activated, as temp sensors can generate a command to activate the heater.
   4. A user with recognized smart phone step in the room. The smart phone is recognized as the user and a script with time in day is activated. For example if a user with recognized smart phone enters a room at night, the switch will send automatically command to light the room's lights. It will auto switch off when the user leaves. Same with air condition.
   OPERATION: Other parts of the virtual switch device will now be described. A user makes a gesture on the hot spot pad surface 100. (Examples of specific gesture types are discussed below.) The hot spot DSP 230 detects and sends it to the processor 260. The processor stores that data on multidimensional table recognizing the use's gesture as a gesture command (referred to as the “gesture signal”) to the controller module 230.

4.3. Alternatives

The virtual switch device recognizes a user by its smart phone, therefore some services are offered to him automatically, just by detecting its smart phone near the virtual switch device.
1. Different command can be active when different user is in a room. For example, a command to lights on, can be done by doing one tapping on a hot spot, and for other by two fingers taping.
2. Virtual switch device as part of several virtual switch devices in a room can recognizes user's location in a room and activates command based on his location and time in the day.
3. As pointer and a ring command.
4. In hotels as an automatic door's key—open/lock.
5. In hotel rooms—light on/off.
6. Light setting by user's preference, over sofa or work place.
7. Automatic home front door lock-when a user leaves and auto open when he returns.
8. And any service based on Identification of the user and his location related to virtual switch devices around.

The virtual switch device can recognizes a user's smart phone location in buildings, waiting nearby and report its location. It can be very helpful for servicing staff in hotels.

In some places it is important to locate movable equipment. Assuming every equipment will be attached by tags operated by Bluetooth Smart tag. The virtual switch devices in every room will detect the tags and mesh this information to controlled units, smart phone or to the internet.

The virtual switch devices can act as electronic key. It can detect the user by its phones and expect him to draw a complex path over its virtual switch device hot spot. Different users can have different “path” key.

Auto on/off if user enters/leaves room/hotel

Virtual switch device can detects other Bluetooth Smart devices low range and mesh their events or commands for far distance based on virtual switch devices mesh network.

Since virtual switch devices recognize the users smart phone it can add a layer of security to the programing of the virtual switch devices and block control command from un authorized users.

Temp sensors will activate house heating cooling/system automatically

Virtual switch device can bridges Bluetooth Smart tag objects, locations, peoples smart phones to the Web

Virtual switch device can have a microphone to bridge voice command to web to be recognized and retrieves a command to activate devices bond to the virtual switch device. For example: voice command as “dim the light 50%”, will be recorded by the virtual switch device, send to internet over table or smart phone, retrieve the recognized text representing the voice command and follow it by activated command to dim the light in the room. This gives the freedom to give a voice command in every language without adding cost to the virtual switch device hardware.

Fix known XYZ position of virtual switch devices to “point and command” devices

The above description of specific embodiments is not intended to limit the claims below. Those of ordinary skill having the benefit of this disclosure will recognize that modifications and variations are possible.

1. A method and apparatus for wireless operating a wireless appliance, the apparatus comprising:
a human finger proximity for receiving a continuous stream of 3 dimensional (3D) gestures performed above the apparatus hot spot 300 receiver area;
a gesture processor DSP 230 that detected the human finger 310 3D hovering above hot spot 300 area.
an operations processor 260 coupled to the gesture processor for identifying an appliance operation associated with the gesture, wherein the gesture is associated with a distinct operation of an appliance; and
a wireless capabilities 200 coupled to the operations processor for sending wireless command causing the appliance with wireless capabilities operation to be performed.

2. The apparatus of claim 1, wherein the apparatus sends a wireless command to appliances that causes the appliance operation to be performed.

3. The apparatus of claim 1, wherein the apparatus sends a wireless command to appliance that wirelessly meshes the command to other appliances causes the other appliances operation to be performed.

4. The apparatus of claim 1, further comprising:
a performance indicator for providing an indication that the dimensional (3D) gestures command has been recognized and wirelessly received by the appliance.

5. The apparatus of claim 1, further comprising:
data storage, readable by the operations processor, for storing data representative of the gesture and of the appliance operation.

6. The apparatus of claim 1, wherein the operations processor comprises:
a 3 dimensional gestures command sampler for sampling the continuous stream of gestures of one or several fingers movement form a discrete sequence of 3D gesture; and
an operations processor for comparing the discrete sequence of 3D gesture to each of one or more stored discrete gesture sequences, and for recognizing the gesture based on the comparison.

7. The apparatus of claim 1, wherein the operations processor identifies the appliance operation by comparing the recognized gesture with each of a predefined set of gestures, wherein each of the predefined gestures is associated with a respective appliance operation.

8. The apparatus of claim 1, further comprising:
environmental sensors coupled to the operations processor and adapted to autonomously wake of the operation processor from sleep, low power saving mode, to retrieve events from the sensors 110

9. The apparatus of claim 1, further comprising:
an environmental sensors coupled to the apparatus and adapted to autonomously sends an event command to operations processor, wherein the operations processor autonomously read the sensors and responsively sends a wireless command to the appliance, for causing, the appliance operation to be performed.

10. The apparatus of claim 1, further comprising:
a housing, on-wall, slim device, few millimeters thin.

11. The apparatus of claim 1, further comprising:
wherein said housing is inside or behind any front surface as a furniture, appliance, doors .

12. The apparatus of claim 1, further comprising:
an infrared remote control recover unit, coupled to the operations processor and adapted to autonomously sends an event to operations processor. The operations processor read the infrared remote control recover unit and responsively sends a wireless command to the appliance, for causing, the appliance operation to be performed.

13. The apparatus of claim 1, further comprising:
an infrared emission unit coupled to the operations processor. The operations processor sends an infrared remote control command responsive to any event input. Event input can be wireless data input or event from sensors. The infrared emission causing the appliance with an infrared remote control unit operation to be performed.

14. The apparatus of claim 1, further comprising:
a Microphone unit coupled to the operation processor. The voice data is wirelessly sent to internet to be a voice command recognized. The return recognized causes the operations processor to send a wireless or infrared command to the appliance, for causing, the appliance operation to be performed.

15. The apparatus of claim 1, further comprising:
an operations processor wireless part, has a RF wireless signal strength unit to detect wireless devices around, as user's smart phone or wearable wireless devices. The signal strength is converting to distance. Changes in the signal strength, sends out a wireless or infrared commands.

16. The apparatus of claim 1, further comprising:
an operations processor has Bluetooth Smart wireless capabilities to allow interfacing to any Bluetooth Smart enable device.

17. The apparatus of claim 1, further comprising:
an operations processor has Wi-Fi capabilities to allow interfacing any Wi-Fi enabling device.

18. The method of claim 1, further comprising:
an operations processor device, wireless mesh out several wireless commands, based on detection set of pre-defined trigger events. An event to several different appliances, operation to be performed.

19. The method of claim 1, further comprising:
a wireless multi node mesh, thus wireless command is meshed from node to node covering all appliances and apparatus in RF node range. The appliances and the apparatus are the nodes in the networks.
